(19) United States
(12) Patent Application Publication
(10) Pub. No.: US 2012/0205174 A1
(43) Pub. Date: Aug. 16, 2012

(54) THREE-WHEEL VEHICLE

(75) Inventors: Bruno BEDARD, Valcourt (CA); Dany DUVAL, Canton d'Orford (CA)

(73) Assignee: BOMBARDIER RECREATIONAL PRODUCTS INC., VALCOURT (CA)

(21) Appl. No.: 13/350,322

(22) Filed: Jan. 13, 2012

Related U.S. Application Data
(63) Continuation of application No. 13/070,204, filed on Mar. 23, 2011, now abandoned.
Application No. 13/070,204 is a continuation of application No. 12/827,787, filed on Jun. 30, 2010, now abandoned.
Application No. 12/827,787 is a continuation of application No. 12/554,252, filed on Sep. 4, 2009, now abandoned.
Application No. 12/554,252 is a continuation of application No. 11/381,793, filed on May 5, 2006, now abandoned.

(51) Int. Cl. B62D 61/06; B62D 25/00

(52) U.S. Cl. 180/210; 296/181.7

(57) ABSTRACT

An three-wheel vehicle including a modular front structure having a storage compartment therein. The modular front structure is adapted to be mounted onto the chassis of the three-wheel vehicle and to support bodywork elements thereby providing ease of assembly of the vehicle and ease of disassembly for packaging the vehicle.

### CROSS REFERENCES TO RELATED APPLICATIONS

The present Utility Patent Application is a continuation of U.S. Utility patent application Ser. No. 13/070,204, filed on Mar. 23, 2011. Through the '204 Application, the present application claims the benefit of priority to U.S. application Ser. No. 12/827,787, filed on Jun. 30, 2010. Through the '787 Application, the present application claims the benefit of priority to U.S. application Ser. No. 12/554,252, filed on Sep. 4, 2009. Through the '252 Application, the present application claims the benefit of priority to U.S. application Ser. No. 11/381,793 filed May 5, 2006. The present application is related to, but does not claim the priority of, U.S. Patent Application Publication No. U.S. 2005/0217909. The contents of these applications are incorporated herein by reference.

### FIELD OF THE INVENTION

The present invention relates to the assembly of three-wheel vehicles and more specifically to the front assembly of a three-wheel vehicle.

### BACKGROUND OF THE INVENTION

Typical three-wheel vehicles having a single rear wheel and a pair of front wheels are based on a motorcycle-like design and include a frame onto which all mechanical, electrical and fairing or bodywork components are mounted. The frame typically extends from the rear suspension of the vehicle to the front portion or nose of the vehicle beyond the front wheels and front suspension of the vehicle. Bodywork panels are mounted to the frame to give the vehicle an aesthetically pleasing look. Similarly, the nose of the vehicle is made of body parts mounted to the frame to hide the mechanical components as well as the frame itself.

The basic layout of a three-wheel vehicle as described above has some drawbacks. For instance, the frame requires an elaborate structure to accommodate the entire bodywork as well as all other mechanical and electrical components. Also, the manufacturing assembly of the vehicle is complicated by the fact that all mechanical, electrical and fairing components are mounted onto an elaborate frame because most of the components must be individually mounted onto the frame. Because of the complexity of the assembly process, the vehicle must be assembled at the manufacturing plant and cannot easily be shipped in subsections. The basic layout of prior three-wheel vehicle renders the assembly as well as the shipping of the vehicle tedious. These drawbacks have an incidence on the cost of the finished product.

Therefore, there is a need for an improved configuration for a three-wheel vehicle to alleviate some of the drawbacks of the prior art configuration.

### STATEMENT OF THE INVENTION

One aspect of the present invention is to provide a three-wheel vehicle having a modular front structure removably mounted to the front portion of the frame via a plurality of anchoring points, the modular front structure being located at least in part between the front left wheel and the front right wheel and including a cavity therein defining a storage compartment.

Another aspect of some embodiments of the present invention is to provide a plurality of attachment points for securing components of the three-wheel vehicle to the modular front structure.

Another aspect of some embodiments of the present invention is that the modular front structure is a molded component including reinforcement elements to increase a load bearing capacity of the modular front structure. Preferably, the reinforcement elements include lattice structures.

Another aspect of some embodiments of the present invention is to provide a modular front structure including a top portion having an opening which gives access to the storage compartment, the width of the storage compartment being wider than a width of the opening.

Another aspect of some embodiments of the present invention is to provide a three-wheel vehicle having a modular front structure removably mounted to the front portion of the frame wherein the modular front structure being located forward of the front wheel axis.

Another aspect of some embodiments of the present invention is to provide a modular front structure wherein some aerodynamic components of the three-wheel vehicle are secured directly to the modular front structure.

Another aspect of some embodiments of the present invention is to provide a modular front structure wherein some fairing components of the three-wheel vehicle are secured directly to the modular front structure.

For the purpose of the present application, the term “modular” is used to define an element as a unit or a sub-assembly that can be handled as a unit.

Embodiments of the present invention each have at least one of the above-mentioned aspects, but not necessarily have all of them.

Additional and/or alternative objects, features, aspects and advantages of the embodiments of the present invention will become apparent from the following description, the accompanying drawings and the appended claims.

### BRIEF DESCRIPTION OF THE DRAWINGS

For a better understanding of the present invention as well as other aspects and further features thereof, reference is made to the following description which is to be used in conjunction with the accompanying drawings, wherein:

FIG. 1 is a front perspective view of a three-wheel vehicle in accordance with an embodiment of the invention;

FIG. 2 is a front elevational view of the three-wheel vehicle illustrated in FIG. 1;

FIG. 3 is a side elevational view of the three-wheel vehicle illustrated in FIGS. 1 and 2;

FIG. 4 is a top plan view of the three-wheel vehicle illustrated in FIGS. 1 to 3;

FIG. 5 is an exploded top plan view of the three-wheel vehicle illustrated in FIGS. 1 to 4;

FIG. 6 is a front perspective view of a modular front structure in accordance with an embodiment of the invention;

FIG. 7 is a side elevational view of the modular front structure illustrated in FIG. 6;

FIG. 8 is a front elevational view of the modular front structure illustrated in FIGS. 6 and 7; and

FIG. 9 is a side elevational view of a modular front structure mounted onto a frame.

### DESCRIPTION OF PREFERRED EMBODIMENT(S)

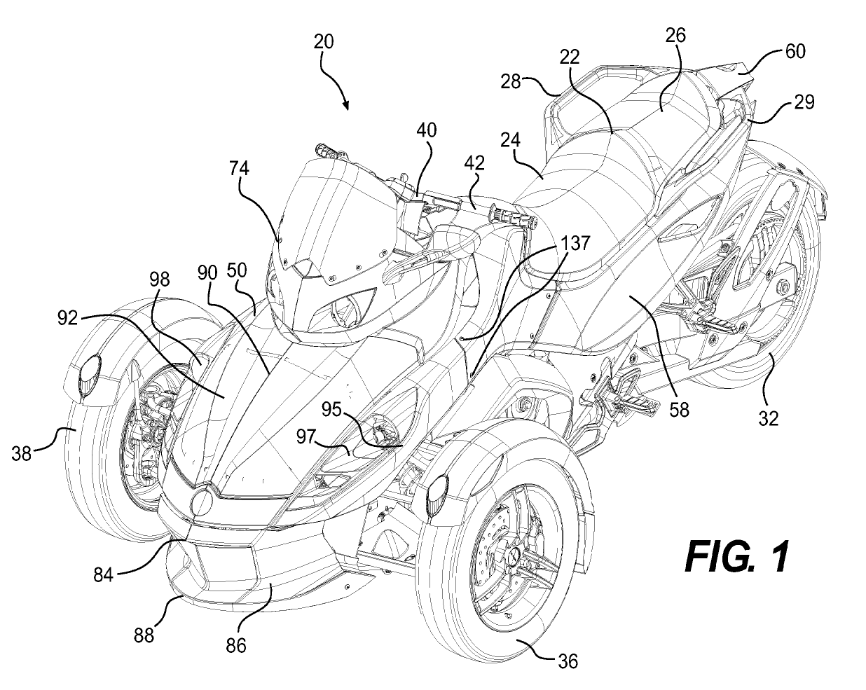

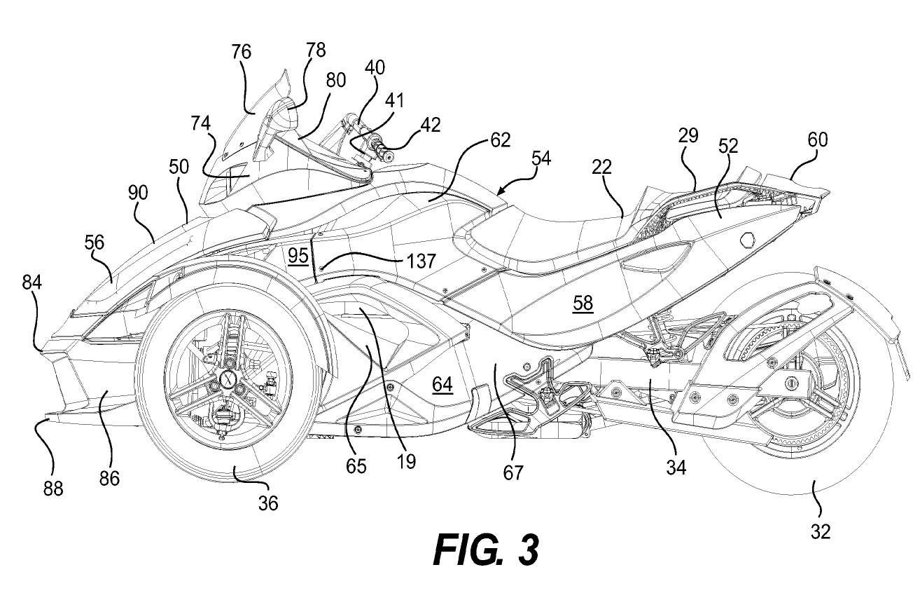

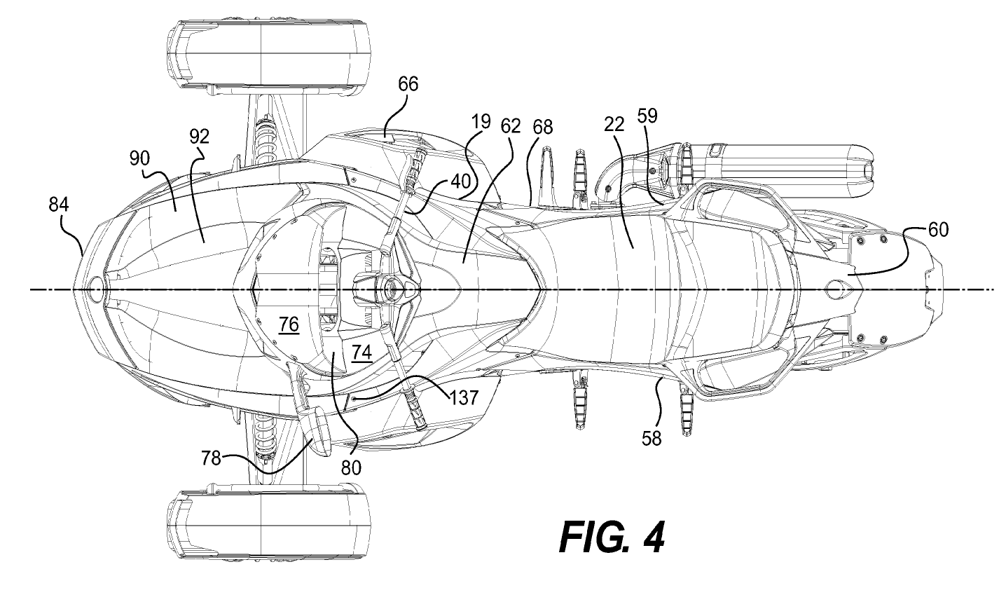

FIGS. 1 to 4 illustrate a three-wheel vehicle 20 in accordance with one specific embodiment of the invention. The three-wheel vehicle 20 is a straddle-type vehicle comprising a straddle seat 22 adapted to accommodate one or two adult sized riders. The straddle seat 22 includes a forward seat portion 24 for the driver and a rear seat portion 26 for a passenger. A pair of handles 28 and 29 is provided on both sides of the rear seat segment 26 for the passenger sitting therein to grip with his hands to maintain his balance.

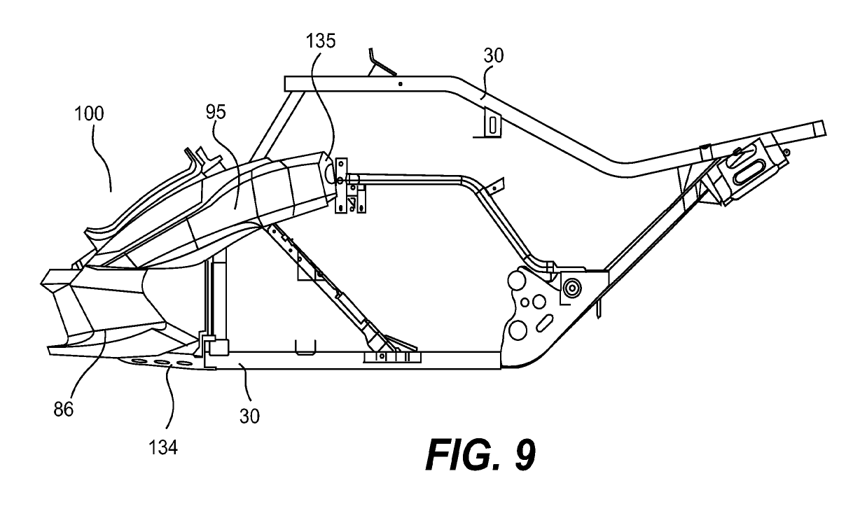

The three-wheel vehicle 20 includes a frame 30 (FIG. 9) underneath the general bodywork 50 of the vehicle 20 that supports and houses an engine 19 located between the straddle seat 22 and the front wheel assemblies 36 and 38. Engine 19 could be any type of power source such as an internal combustion engine or an electric motor if desired. A single rear wheel assembly 32 with a tire suitable for road use is suspended from the vehicle 20 via a rear suspension system 34 at the rear of the frame 30. The single rear wheel assembly 32 is operatively connected to the engine 19 through any suitable power transmission mechanism such as gearbox or continuously-variable transmission coupled to an endless belt, chain, or driveshaft assembly. A pair of front wheel assemblies 36 and 38 are suspended from the front of the frame 30 through suitable suspension assembly such as upper and lower A-arms. Dampening mechanisms such as shock absorbers and coil springs assembly are connected to the suspension assembly to increase ride comfort and vehicle stability. Front wheel assemblies 36 and 38 have road tires mounted thereon.

A steering assembly 40 is coupled to the front wheel assemblies 36 and 38 and is supported by the frame 30 for transmitting steering commands to the front wheel assemblies 36 and 38. The steering assembly 40 includes a steering column 41 and a steering control mechanism 42, such as a handle bar, steering wheel, or other known steering control mechanism.

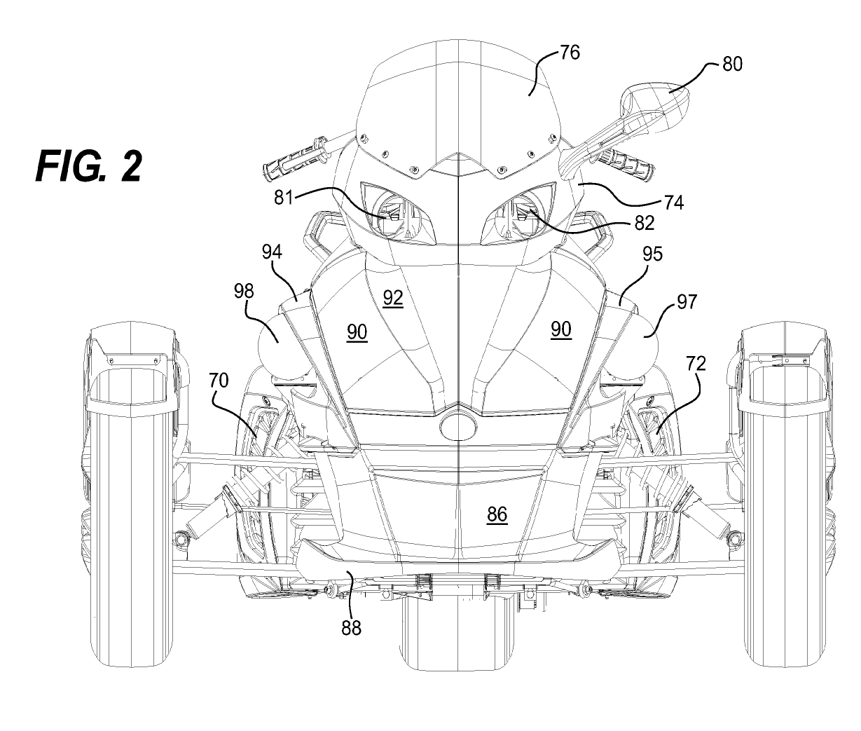

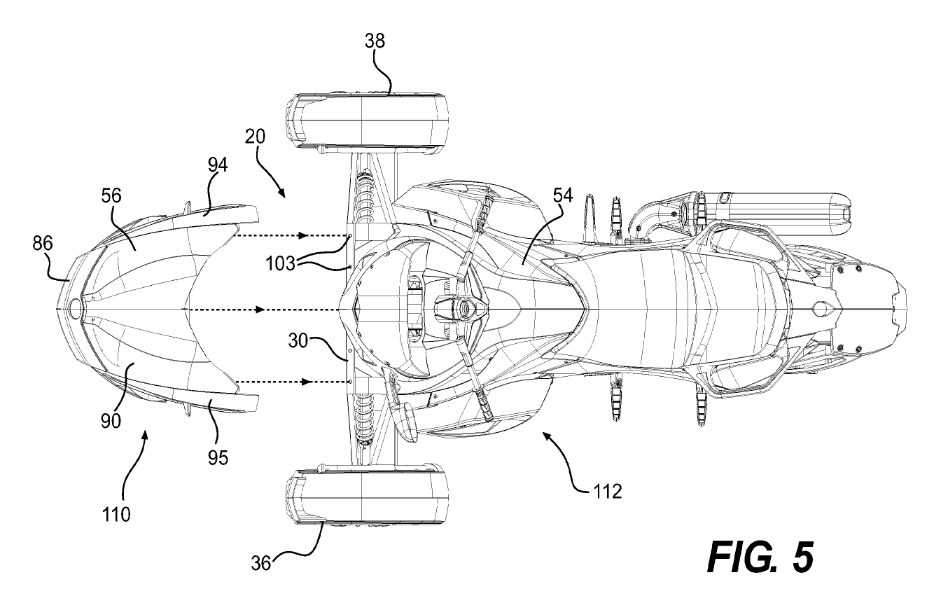

Three-wheel vehicle 20 includes an elaborate bodywork 50 covering the mechanical components of the vehicle. Bodywork 50 includes a rear portion 52, a central portion 54 and a front portion 56. The rear portion 52 consists of the straddle seat 22, the handles 28 and 29, fairing side panels 58 and 59 disposed below and on each side of straddle seat 22, and a rear deflector 60 to prevent ingress of debris or water thrown by the rear wheel assembly 32. The central portion 54 consists of an upper fairing 62 extending from the forward end of the straddle seat 22 to the steering assembly 40 and extending downwardly on both sides of vehicle 20 to cover the top portion of the engine 19 (not shown). The upper fairing 62 extends rearward to merge with the side panels 58 and 59 below straddle seat 22. The central portion 54 also features a lower fairing 64 consisting of a left air intake cover 65 and a right air intake cover 66 and lower side panels 67 and 68 extending from the air intake covers 65 and 66 respectively towards the rear of the vehicle 20 to merge with the side panels 58 and 59. The left air intake cover 65 protects the radiator of the vehicle whereas the right air intake cover 66 protects the oil cooler of the vehicle 20. The air intake covers 65 and 66 also enclose the lower portion of the engine and the lower side panels 67 and 68 enclose the transmission and the attachment points of the rear suspension 34. The front facing portion of the air intake covers 65 and 66 includes air intake openings 70 and 72 adapted to scoop and direct air towards the radiator and oil cooler to provide sufficient air flow for efficient heat exchange. The central portion 54 also includes an upper segment 74 surrounding the steering assembly 40 to which is mounted a windshield 76, at least one side view mirror 78 and a dashboard panel 80 for mounting various gauges and indicators. The upper segment 74 may optionally include a single headlight or a pair of headlights 81 and 82 as illustrated in FIG. 2. The upper segment 74 of the central portion 54 extends from the upper fairing 62 to the front portion 56 of the bodywork 50 to enclose the steering column 41. All the elements of the rear and central portions 52 and 54 of bodywork 50 are typically secured directly onto the frame 30 illustrated in FIG. 5.

The front portion 56 of the bodywork 50 extends from the central portion 54 all the way to the nose 84 of vehicle 20. Front portion 56 includes a lower deflector 86 extending laterally and rearwardly from the nose 84 to the front suspension on either side of vehicle 20. Lower deflector 86 defines the lower portion of the front end of vehicle 20 and is adapted to direct air flow towards the air intake openings 70 and 72 of the air intake covers 65 and 66. Lower deflector 86 may feature a lower lip 88 to provide a well defined channel to direct event air flow to the air intake covers 65 and 66 and to prevent air from above the lower lip 88 to flow under the vehicle 20. The lower lip 88 may thereby add some aerodynamic downforce to the front of the vehicle 20. The front portion 56 of the bodywork 50 also features a hood panel 90 extending from the lower deflector 86 to the upper segment 74 of central portion 54 which defines the upper portion of the front end of vehicle 20 and covers a storage compartment underneath and is therefore adapted to be opened and closed. The hood panel 90 is designed to direct air flow over and around the vehicle 20 and may further comprises air channels 92 to provide specific aerodynamic flow over and around the vehicle 20. Because of its large surface area, hood panel 90 provides a substantial amount of aerodynamic downforce to the front of the vehicle 20. The front portion 56 of the bodywork 50 also includes a pair of side panels 94 and 95 extending between the lower deflector 86 and each side of hood panel 90 and rearwardly from lower deflector 86 to the upper fairing 62 of central portion 54. Side panels 94 and 95 may each include a headlights 97 and 98 and receptacle therefor.

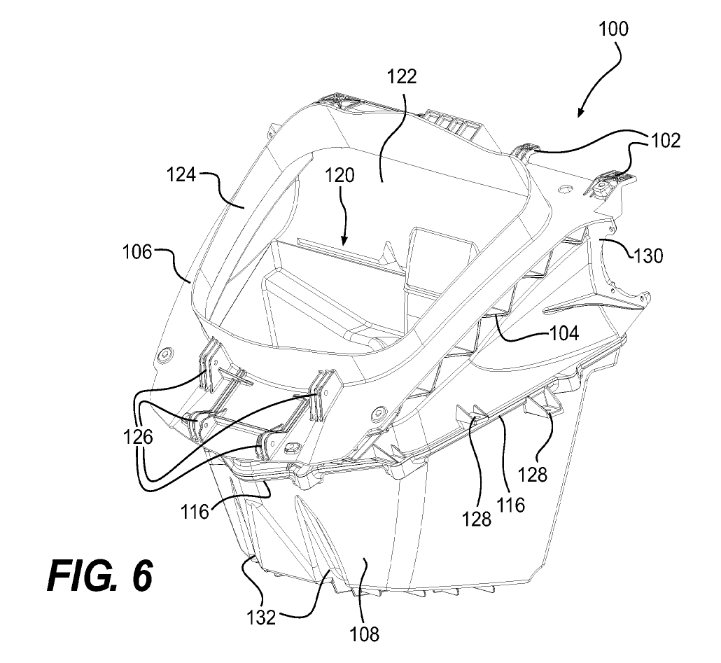

As illustrated in FIG. 5, The entire front portion 56 of the bodywork 50 is removably mounted to the front portion of frame 30. The hood panel 90, side panels 94 and 95 and the lower deflector 86 are mounted on a modular front structure 100 illustrated in FIG. 6. The modular front structure 100 includes a series of anchoring brackets 102 which are precisely aligned with respective anchoring holes 103 located on the front portion of the frame 30 so that the entire front portion 56 of the bodywork 50 may be easily mounted to the frame 30 with fasteners. Obviously, anchoring brackets may be located on the frame 30 and anchoring holes may be located on the modular front structure 100. As illustrated in FIG. 5, the modular front structure 100 is located forward of the front wheel axis of the three-wheel vehicle 20. The front wheel axis referring to a line drawn through the centers of the front wheels 36 and 38. The three-wheel vehicle 20 may be easily disassembled into two sections 110 and 112 such that the three-wheel vehicle 20 may be encased into a smaller and shorter crate or container for ease of transportation. The front wheel assemblies 36 and 38 may also be removed to further reduce the over length of section 112 allowing the use of an even shorter crate or container.

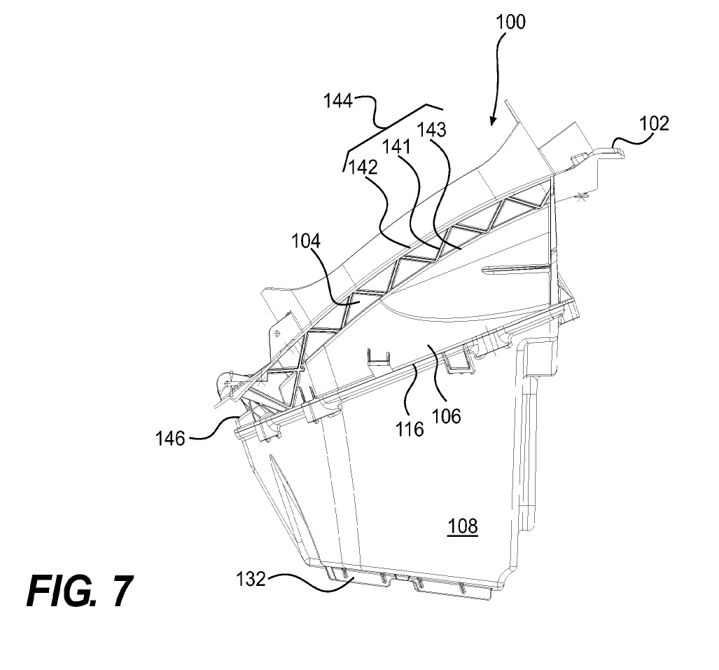

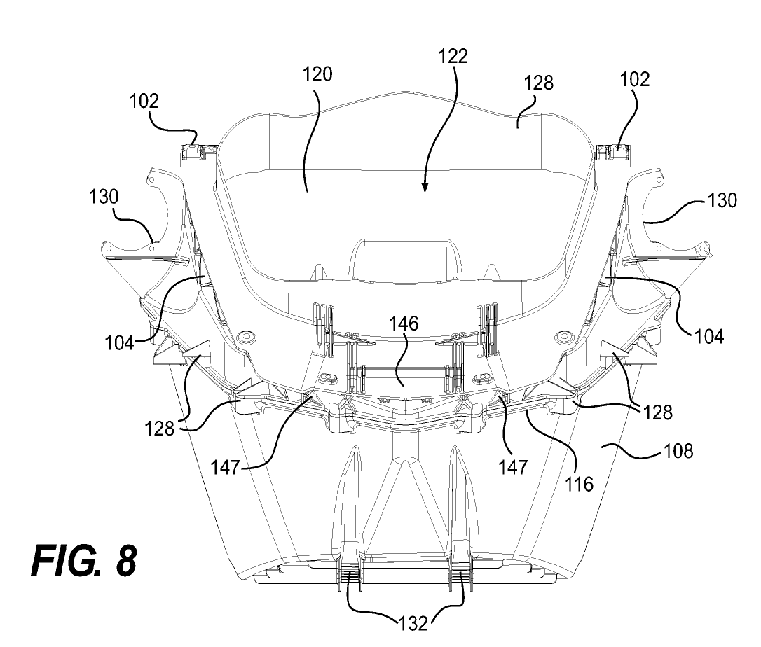

The modular front structure 100 illustrated in FIGS. 6 to 8 is a molded plastic component made of an upper section 106 and a lower section 108, both being molded components which are permanently assembled by welding, gluing or any other known method to form the modular front structure 100. Other manufacturing processes may be used that will produce a seamless modular front structure 100. The upper section 106 is assembled to the lower section 108 at the seam 116. The upper section 106 of modular front structure 100 includes reinforcement elements 104 to increase the load bearing capacity of modular front structure 100. As illustrated more specifically in FIG. 7, each reinforcement element 104 is in the form of a lattice structure 141 sandwiched between an upper segment 142 and a lower segment 143 to form an integrated beam 144. The reinforcement elements 104 extend on both sides of the upper section 106 from the anchoring brackets 102 to the front segment 146 of the upper section 106. As illustrated in FIG. 8, a lattice structure 147 is provided on the front segment 146 that bridge the two reinforcement elements 104 to provide increased rigidity to modular front structure 100. Since modular front structure 100 is supporting the front portion 56 of the bodywork 50 which includes aerodynamic components that may generate substantial aerodynamic downforces when three-wheel vehicle 20 is moving at speeds of 40 km/hr or more, the modular front structure 100 must be sufficiently rigid to bear these forces and transfer them to the frame 30. The molded construction of modular front structure 100 including the lattice structure 141 and 147 provide added rigidity for the structure to bear these aerodynamic loads.

Modular front structure 100 includes a large cavity defining a storage compartment 120. The storage compartment 120 is sized to receive at least one helmet and may include a removable insert having separate storage compartments formed therein. Access to storage compartment 120 is provided through an opening 122. The opening 122 is circumscribed by a boundary edge or lip 124 which further increases the rigidity of the modular front structure 100. Attachment points 126 are provided to pivotally mount the hood panel 90 to the upper section 106 of modular front structure 100 to close the storage compartment 120. The side of the hood panel 90 facing the storage compartment 120 is preferably designed to receive and unite with the edge or lip 124 of the modular front structure 100 to provide a tight fit of the two components. A locking mechanism (not shown) is preferably used to secure the hood panel 90 to the modular front structure 100 when in the closed position.

As best shown in FIG. 8 which is a front elevational view of modular front structure 100, the storage compartment 120 which is defined by the inside walls of the upper lower portion 106 and 108 is larger and wider than opening 122. Specifically, lower portion 108 which is permanently affixed to the upper portion 106 at the seam 116, is wider than the opening 122. The molded construction of modular front structure 100 allows an efficient use of the space available such that the storage compartment 120 has a maximum volume from the available space at the front of three-wheel vehicle 20.

Modular front structure 100 further includes attachment brackets 128 to secure the side panels 94 and 95 and the lower deflector 86 and may include receptacles 130 for mounting headlights.

As best shown in FIGS. 7 and 8, the lower section 108 of modular front structure 100 includes a pair of channels 132 which extend upwardly onto the front end of the lower section 108. Channels 132 are adapted to receive a pair of brackets 134 which are mounted via fasteners to the bottom of the front end of fame 30 as illustrated in FIG. 9. Brackets 134 are anchored within the channels 132 and provide additional support for modular front structure 100.

The side panels 94 and 95, the headlights 97 and 98, the lower deflector 86 as well as the brackets 134 and the hood panel 90 are preferably assembled to the modular front structure 100 prior to mounting the modular front structure 100 to the front portion of frame 30 such that the entire front end of three-wheel vehicle 20 may be mounted to the frame 30 as one piece unit. To fasten the modular front structure 100 to the front portion of frame 30, the hood panel 90 must be in the open position in order to give access to the anchoring brackets 102 and holes 103. As shown in FIG. 9, the modular front structure 100 may also be mounted onto the front portion of frame 30 without the hood panel 90 in order to give access to the anchoring brackets 102 and holes 103. Hood panel 90 is thereafter assembled to the modular front structure 100 to complete the assembly. Side panels 94 and 95 which extend rearwardly to merge with the upper fairing 62 of central portion 54 are provided with recesses 135 designed to fit underneath the forwardmost portion of upper fairing 62. Fasteners 137 are used to secure the two components together. The modular front structure 100 is easily removed from the frame 30 or easily assembled to the frame 30 as one large component without requiring the removal or assembly of the side panels 94 and 95, the headlights 97 and 98, the lower deflector 86 and the hood panel 90. The process of assembly or disassembly is simplified and requires few tools.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1. A three-wheel vehicle comprising:
a frame having a front portion and a rear portion, the front portion having a plurality of anchoring points;
an engine supported by the frame;
a front left wheel and a front right wheel connected to the front portion of the frame via a front suspension;
a single rear wheel connected to the rear portion of the frame via a rear suspension, at least one of the wheels being operatively connected to the engine;
a steering assembly supported by the frame and operatively connected to the front left wheel and the front right wheel; and
a straddle seat disposed on the frame; and
a modular front structure removably mounted to the front portion of the frame at the anchoring points via fasteners, sufficient ones of the fasteners being accessible to a user to permit removal of the modular front structure from the frame without disassembly of the modular front structure, the modular front structure defining a storage compartment and having an opening giving access to the storage compartment, and
a plurality of front bodywork elements associated with the modular front structure.

2. The three-wheel vehicle of claim 1, wherein at least some of the plurality of front bodywork elements are attached to the modular front structure.

3. The three-wheel vehicle of claim 2, wherein the sufficient ones of the fasteners are further accessible to the user to permit removal of the modular front structure from the frame and those of the plurality of front bodywork elements that are attached thereto as a unit without detachment of at least some of those of the plurality of front bodywork elements from the modular front structure.

4. The three-wheeled vehicle of claim 3, wherein, when the unit is removed, a length of the vehicle is shorter.

5. The three-wheeled vehicle of claim 4, wherein, when the front left wheel and the front right wheel are removed from the vehicle, the length of the vehicle is even shorter.

6. The three-wheel vehicle of claim 3, wherein at least one of the plurality of bodywork elements is also attached to a bodywork element other than the bodywork elements associated with the modular front structure.

7. The three-wheel vehicle of claim 2, wherein the sufficient ones of the fasteners are further accessible to the user to permit removal of the modular front structure from the frame and those of the plurality of front bodywork elements that are attached thereto as a unit without detachment of those of the plurality of front bodywork elements from the front modular structure.

8. The three-wheeled vehicle of claim 7, wherein, when the unit is removed, a length of the vehicle is shorter.

9. The three-wheel vehicle of claim 7, wherein at least one of the plurality of bodywork elements is also attached to a bodywork element other than the bodywork elements associated with the modular front structure.

10. The three-wheel vehicle of claim 1, wherein the modular front structure is a molded component including reinforcement elements to increase a load bearing capacity of the modular front structure.

11. The three-wheel vehicle of claim 10, wherein the reinforcement elements include lattice structures.

12. The three-wheel vehicle of claim 1, wherein the modular front structure includes a top portion and a bottom portion, the bottom portion being permanently affixed to the top portion to form the modular front structure.

13. The three-wheel vehicle of claim 1, wherein one of the modular front structure and the front portion of the frame has at least one bracket disposed thereon at at least one of the plurality of anchoring points, the other of the modular front structure and the front portion of the frame has at least one recess formed therein at at least a corresponding one of the plurality of anchoring points, the at least one recess being aligned with the at least one bracket, and at least one of the fasteners fastening the bracket via the recess.

14. The three-wheel vehicle of claim 1, wherein the modular front structure includes a bottom portion and a pair of channels extending upwardly onto a front end of the bottom portion, the pair of channels mounted to a pair of brackets via fasteners for providing support to the modular front structure, the pair of brackets being mounted onto a bottom of the front portion of the frame.

15. The three-wheel vehicle of claim 1, wherein the front left wheel and the front right wheel each have a center, and a line passing through the centers of both front wheels defines a front wheel axis, the modular front structure being located forward of the front wheel axis between the front left wheel and the front right wheel.

16. The three-wheel vehicle of claim 1, wherein an access panel is movably connected to the modular front structure for covering the top portion of the modular front structure and closing the opening.

17. The three-wheel vehicle of claim 16, wherein the access panel is a hood of the vehicle.

18. The three-wheel vehicle of claim 1, wherein the modular front structure includes a top portion having the opening, a width of the storage compartment being wider than a width of the opening.

19. The three-wheel vehicle of claim 18, further comprising a hood movable between an open position and a closed position, the sufficient ones of the fasteners being accessible to the user when the hood is in the open position and being inaccessible to the user when the hood is in the closed position.

20. The three-wheel vehicle of claim 18, further comprising a hood removably attached to the modular front structure, the sufficient ones of the fasteners being accessible to the user when the hood is removed from the modular front structure and being inaccessible to the user the hood is attached to the modular front structure.
